(19) United States
(12) Patent Application Publication
(10) Pub. No.: US 2005/0261974 A1
(43) Pub. Date: Nov. 24, 2005

(54) Touch screen ordering system for fast food sales

(76) Inventor: Gary Podratz, Redlands, CA (US)

Correspondence Address: Gary Eugene Podratz, 140 W. Pioneer # 78, Redlands, CA, 92374, US

(21) Appl. No.: 10/834,957

(22) Filed: Apr. 30, 2004

(51) Int. Cl. G06F 17/60

(52) U.S. Cl. 705/22

(57) ABSTRACT

A touch screen ordering system for fast food sales that includes a number of transaction language selection keys; a payment type selection key for allowing payment to be made via cash, charge, debit, check, etc.; a touch screen menu item display as well as offered menu item options display; an enter menu item selection; an enter additional menu item key; a running display showing total payment due as well as total items ordered; a submit order for preparation; an approximate order preparation time; and a total fee for meal.

### TECHNICAL FIELD

The present invention relates to an ordering system of a fast food restaurant that includes a number of transaction language selection keys; a payment type selection key for allowing payment to be made via cash, charge, debit, check, etc.; a touch screen menu item display as well as offered menu item options display; an enter menu item selection; an enter additional menu item key; a running display showing, total payment due as well as total items ordered; a submit order for preparation; an approximate order preparation time; and a total fee for meal; in an optional embodiment, the ordering system is provided at a counter or at a table to allow dine-in customers the same conveniences as the drive through customers.

### BACKGROUND ART

Many times drive through customers receive the wrong food order because the microphone system at a drive-up window at a take out restaurant is difficult to hear over the engine noises, street sounds, radios, etc. The errors inherent in an audio messaging/order taking system could be eliminated by a touch screen ordering system for fast food sales. The ordering system would preferably allow the customer to select an ordering language by depressing one of several language selection keys. In addition, once a menu item is selected, the options are shown to the customer who promptly selects those desired; then moves on to additional items. Once all the desired items are ordered, the price total is given and an accurate preparation time is provided to the customer. In a preferred embodiment order input units or put inside the restaurant, either at the service counter or at the tables.

### GENERAL SUMMARY DISCUSSION OF INVENTION

It is thus an object of the invention to provide a touch screen ordering system for fast food sales that includes a number of transaction language selection keys; a payment type selection key for allowing payment to be made via cash, charge, debit, check, etc.; a touch screen menu item display as well as offered menu item options display; an enter menu item selection; an enter additional menu item key; a running display showing total payment due as well as total items ordered; a submit order for preparation; an approximate order preparation time; and a total fee for meal; in an optional embodiment, the ordering system is provided at a counter or at a table to allow dine-in customers the same conveniences as the drive through customers.

Accordingly, a touch screen ordering system for fast food sales is provided. The touch screen ordering system for fast food sales includes a number of transaction language selection keys; a payment type selection key for allowing payment to be made via cash, charge, debit, check, etc.; a touch screen menu item display as well as offered menu item options display; an enter menu item selection; an enter additional menu item key; a running display showing total payment due as well as total items ordered, a submit order for preparation; an approximate order preparation time display; and a total fee for meal; in an optional embodiment, the ordering system is provided at a counter or at a table to allow dine-in customers the same conveniences as the drive through customers.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a perspective view of an exemplary embodiment of an out-door drive-thru embodiment of the touch screen ordering system for fast food sales of the present invention.

FIG. 2 is, a perspective view of an exemplary in-store exemplary touch screen ordering system for fast food sales.

### EXEMPLARY MODE FOR CARRYING OUT THE INVENTION

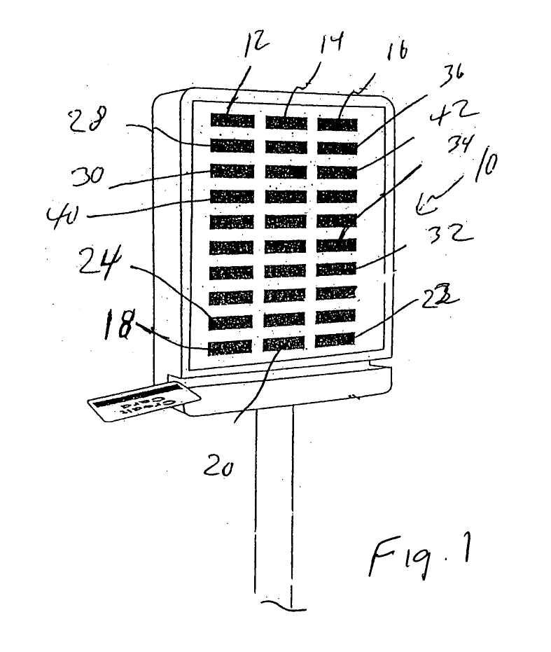

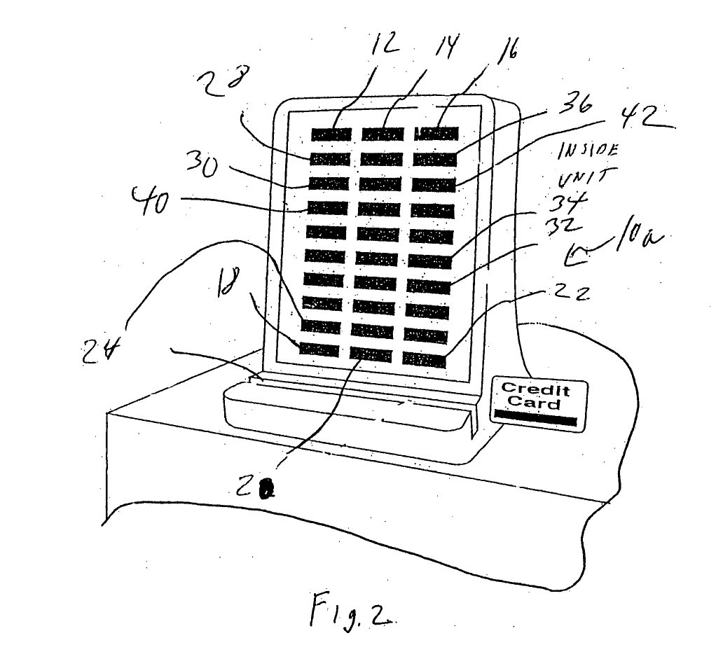

FIGS. 1 and 2 show various aspects of exemplary embodiment of the touch screen ordering system for fast food sales of the present invention generally designated 10, 10a. Touch screen ordering system for fast food sales 10 is an out-door unit for drive-through ordering. Touch screen ordering system for fast food sales 10a is an in-store unit for dine-in customers. Both systems 10, 10a operate in the same fashion.

The system includes a number of transaction language selection keys 12, 14, 16; a payment type selection key for allowing payment to be made via cash 18, charge 20, debit 22, check 22, etc. 24; a touch screen menu item display, generally designated 28, as well as offered menu item options display 30; an enter menu item selection key 32; an enter additional menu item key 34; a running display showing total payment due 36 as well as total items ordered 38 display; a submit order for preparation key 40; an approximate order preparation time display 42; and a total fee for meal 44.

In an optional embodiment 10a, the ordering system is provided at a counter or at a table to allow dine-in customers the same conveniences as the live through customers.

It can be seen from the preceding description that a touch screen ordering system for fast food sales has been provided.

It is noted that the embodiment of the touch screen ordering system for fast food sales described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1) A touch screen ordering system for fast food sales comprising:
a number of transaction language selection keys; a payment type selection key for allowing payment to be made via cash, charge, debit, check, etc.; a touch screen menu item display as well as offered menu item options display; an enter menu item selection; an enter additional menu item key; a running display showing total payment due as well as total items ordered; a submit order for preparation; an approximate order preparation time; and a total fee for meal; in an optional embodiment, the ordering system is provided at a counter or at a table to allow dine-in customers the same conveniences as the drive through customers.
